(19) United States
(12) Patent Application Publication
(10) Pub. No.: US 2003/0036032 A1
(43) Pub. Date: Feb. 20, 2003

(54) Articulator having a securable mounting

(76) Inventors: Terry L. Jackson, St. Louis, MO (US); Nicholas R. Pacino JR., St. Louis, MO (US)

Correspondence Address: David H. Chervitz, Polster, Lieder, Woodruff & Lucchesi, L.C., 763 South New Ballas Road, St. Louis, MO, 63141, US

(21) Appl. No.: 10/217,040

(22) Filed: Aug. 12, 2002

Related U.S. Application Data
(63) Continuation-in-part of application No. 09/916,950, filed on Jul. 27, 2001.
Application No. 09/916,950 is a continuation-in-part of application No. 09/826,184, filed on Apr. 4, 2001, now Pat. No. 6,394,804.

(51) Int. Cl. A61C 11/00

(52) U.S. Cl. 433/64; 433/66

(57) ABSTRACT

An articulator for positioning a pair of dental casts relative to each other, the articulator comprising a pair of members adapted to being connected to each other for pivotal movement relative to each other, each member comprising a central portion having a ball connected to the central portion by a spline, the ball being expandable for securing the ball within a mounting.

### CROSS REFERENCE TO RELATED APPLICATIONS

This application is a continuation-in-part of prior U.S. patent application Ser. No. 09/916,950 which was filed on Jul. 27, 2001, which was a continuation-in-part of prior U.S. patent application Ser. No. 09/826,184 which was filed on Apr. 4, 2001, and is now U.S. Pat. No. 6,394,804.

### BACKGROUND OF THE INVENTION

This invention relates to an articulator used in conjunction with dental casts, and more particularly, to an articulator having a securable mounting.

Articulators are used in conjunction with casts of a dental model in order for a technician to develop, construct, or form prosthetic dentures or other denture elements. A dentist makes the dental casts of both the upper and lower jaws of a patient by using any well known casting methods. The technician uses these casts to shape or fit the denture elements in order to correct any dental problems. The articulator is attached to both of the dental casts by use of mountings. Once attached, the articulator is used to simulate the movement of the jaws relative to each other and the technician uses this movement to confirm proper registration or fit of the denture elements. It is important for the articulator to be able to allow the casts to move in all directions in order for the technician to verify the correctness of the dentures or the denture elements. For example, the articulator needs to be able to allow movement of the casts in order to confirm the registration of all opposed dental surfaces. Articulators have been constructed or formed of different materials and different details of construction. Known articulators range from simple designs to complex mechanical designs. Such articulators also range in price from inexpensive to expensive.

Additionally, the mountings are connected to the dental casts with the mountings having a socket portion of a ball and socket joint. The articulators typically have the ball portion which fits into the socket portion associated with the mountings. In this manner, the articulator is able to move relative to the dental casts. Once it is determined that the dental elements have successful registration, any movement of the articulator relative to the mountings should be fixed. Typically, the ball portions of the articulator are bonded to the socket portions of the mountings by use of an adhesive or glue such as cyano acrylate. However, this method is unacceptable for several reasons. One reason is that when gluing the portions together the dental casts may come out of alignment or registration. Another reason is that once glued, if realignment or further adjustment is required then the mountings and the articulator must be destroyed or discarded. Further, once glued, the mounting and the articulator may not be reused for constructing dental appliances for others. Another reason is that this method is unacceptable is that the glue used is hazardous if not properly handled.

The present invention is designed to obviate and overcome many of the disadvantages and shortcomings associated with presently available methods and constructions of fixing or securing mountings relative to articulators. In particular, the present invention is an articulator that is designed and constructed to be secured to a mounting with the articulator and the mounting also being capable of being disassembled or reused. Moreover, the articulator having a securable mounting of the present invention can be employed to construct dental devices and to register such devices in an accurate manner and alignment. The articulator having a securable mounting of the present invention is also adjustable over a full range of motion that is required for proper registration or alignment of prosthetic dentures or other denture elements.

### SUMMARY OF THE INVENTION

In one form of the present invention, an articulator for positioning a pair of dental casts relative to each other comprises a pair of members adapted to being connected to each other for pivotal movement relative to each other, each member comprising a central portion having a ball connected to the central portion by a spline, the ball being expandable for securing the ball within a mounting.

In another form of the present invention, an articulator for positioning a pair of dental casts relative to each other comprises a pair of members adapted to being connected to each other for pivotal movement relative to each other, each member comprising a central portion having a ball connected to the central portion by a spline, an opening in the central portion and aligned with the spline and the ball, the ball being expandable, and a securing device adapted for insertion into the opening, through the spline and into the ball for expanding the ball when the ball is positioned within a mounting.

In yet another form of the present invention, an articulator for positioning a pair of dental casts relative to each other comprises a pair of members adapted to being connected to each other for pivotal movement relative to each other, each member comprising a central portion and a ball connected to each of the central portions, the ball being expandable, and a securing device for expanding the ball when the ball is inserted into a mounting.

In light of the foregoing comments, it will be recognized that a principal object of the present invention is to provide an articulator having a securable mounting.

A further object of the present invention is to provide an articulator having a securable mounting which is of simple construction and design, is inexpensive, and which can be easily employed with highly reliable results.

Another object of the present invention is to provide an articulator having a securable mounting that is easy to use and may be moved or operated through a large degree of motion or movement.

A still further object of the present invention is to provide a mounting that can be secured to and released from an articulator.

A further object of the present invention is to provide an articulator having a securable mounting which may be used to prepare and construct a dental appliance or restoration.

Another object of the present invention is to provide an articulator having a securable mounting which simulates jaw movement in order for a technician to construct a dental appliance and to verify proper alignment of the dental appliance.

A further object of the present invention is to provide an articulator having a securable mounting that is strong and flexible and has unitary construction.

Another object of the present invention is to provide an articulator having a securable mounting that may be easily repositioned.

These and other objects and advantages of the present invention will become apparent after considering the following detailed specification in conjunction with the accompanying drawings, wherein:

### BRIEF DESCRIPTION OF THE DRAWINGS

FIG. 1 is a side view of a preferred embodiment of an articulator having a pair of securable mountings constructed according to the present invention with the pair of mountings being mounted to a pair of dental molds;

FIG. 2 is a top view of the articulator of the present invention with the securable mountings being removed;

FIG. 3 is a side view of a mounting and a side partial view of the articulator with the articulator being positioned into the mounting;

FIG. 4 is a perspective view of another preferred embodiment of an articulator constructed according to the present invention;

FIG. 5 is a partial top view of the articulator shown in FIG. 4;

FIG. 6 is a side view of another preferred embodiment of a mounting for an articulator for dental casts constructed according to the present invention;

FIG. 7 is a front view of the mounting shown in FIG. 7; and

FIG. 8 is a top view of another preferred embodiment of a mounting for an articulator for dental casts constructed according to the present invention.

### DETAILED DESCRIPTION OF THE PREFERRED EMBODIMENTS

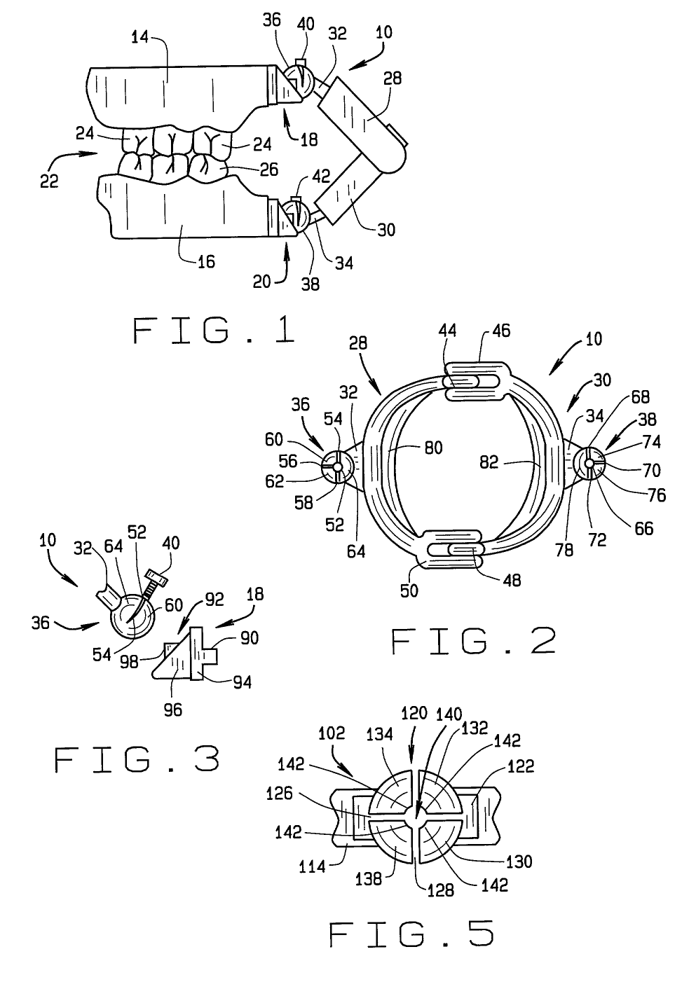

Referring now to the drawings, wherein like numbers refer to like items, number 10 identifies a preferred embodiment of an articulator 10 constructed according to the present invention. With reference now to FIG. 1, the articulator 10 is shown being mounted to a first or upper dental cast 14 and a second or lower dental cast 16 by use of a pair of mountings 18 and 20, respectively. The dental casts 14 and 16 are used to simulate a mouth 22, such as a person who needs to have dentures or other dental appliances. The mouth 22 can include teeth 24 which simulate the teeth of a person. Additionally, the mouth 22 may have a tooth 26 which may be a prosthetic or false tooth composed of a synthetic material such as gold or porcelain. The tooth 26 must be configured and shaped to naturally mate with or align with the tooth 24. The tooth 24 may be a simulation of an actual tooth in the mouth of a person with which the tooth 26 must contact. The casts 14 and 16 may be formed of any known casting material used for making such casts 14 and 16. Further, the teeth 24 are cast from the same material. Also, the mouth 22 may have more than one tooth 26 which needs to be constructed or fabricated for an individual.

The articulator 10 is shown to be comprised of a pair of interconnecting members 28 and 30 that are positioned within the pair of mountings 18 and 20, respectively. Each of the members 28 and 30 has a spline portion 32 and 34, respectively. A ball 36 is connected to the spline 32 and a ball 38 is connected to the spline 34. The mountings 18 and 20 are sized and shaped to receive and capture the balls 36 and 38. In this manner, the members 28 and 30 are free to move or rotate within the mountings 18 and 20. In order to secure the balls 36 and 38 within the mountings 18 and 20, the balls 36 and 38 each further comprise a fastening or securing device 40 and 42, respectively, such as a screw, set screw, or thumb screw. As will be explained, the securing devices 40 and 42 are used to secure the members 28 and 30 of the articulator 10 relative to the mountings 18 and 20. In particular, the ball 36 is sectioned and has an opening (not shown), which receives the device 40 in order for ball 36 to spread out to lock or secure the ball 36 within the mounting 18. The ball 38 is also sectioned and has an opening (not show) that receives the device 42 for spreading the ball 38.

As can be appreciated, the casts 14 and 16 in conjunction with the articulator 10 and the mountings 18 and 20 may be moved relative to each other in order to simulate the movement of a person's jaws. By use of the articulator 10, the tooth 26 can be viewed to determine if the tooth 26 will impact or mate with the tooth 24 in order for a technician to verify the correctness of the fit of the tooth 26. If it is determined that the teeth 24 and 26 are not mating correctly, then the technician can make adjustments or alterations to the tooth 26. The articulator 10 also allows the technician to move or rotate either of the casts 14 or 16 apart from each other in order to view the tooth 26.

With reference now to FIG. 2, the members 28 and 30 are shown connected together to form the articulator 10. As is shown, a first end 44 of the member 28 is connected to or hooked onto a second end 46 of the member 30. Further, a first end 48 of the member 30 is connected to a second end 50 of the member 28. As can be appreciated, there are other constructions for connecting together the members 28 and 30 of the articulator 10. The member 28 is shown having the spline 32 connecting the ball 36 to the member 28. The ball 36 has an aperture or opening 52 which is adapted for receiving the securing device 40. The ball 36 is also sectioned by the use of slits or cuts 54, 56, and 58. The slits 54, 56, and 58 are used to provide sections 60, 62, and 64. The slits 54, 56, and 58 allow the sections 60, 62, and 64 to spread out or expand when the securing device 40 is inserted into the opening 52. In this manner, the sections 60, 62, and 64 of the ball 36 open outwardly and contact the mounting 18 when the ball 36 is positioned therein. The ball 38 is similarly constructed having an opening 66 for receiving the securing device 42 and slits 68, 70, and 72 for partitioning the ball 38 into sections 74, 76, and 78. As was indicated previously, when the securing device 42 is inserted into the opening 66, the sections 74, 76, and 78 are forced outwardly to contact the mounting 20 to secure the ball 38 in place within the mounting 20. Although only three slits 54, 56, and 58 are shown in the ball 36 and only three slits 68, 70, and 72 are shown in the ball 38, it is to be understood that more or less slits may be formed in the balls 36 and 38. Further, each of the members 28 and 30 may have a reinforcing rib 80 and 82, respectively.

FIG. 3 illustrates a side view of the mounting 18 about to receive the ball 36 of the articulator 10. The mounting 18 is shown to have a tongue portion 90 and a cup or socket portion 92. The tongue portion 90 is connected to a wall portion 94. The tongue portion 90 and the wall portion 94 are generally T-shaped. The tongue portion 90 is adapted to being inserted into a groove that is formed in the dental cast 14 for mounting the dental cast 14 to the mounting 18. The mounting 18 further comprises a side 96 with the side 96 having a pair of extensions 98, one of which is visible, which are used to help retain the ball 36 when the ball 36 is seated within the cup portion 92. The side 96 is integrated with the wall 94 with both the wall 94 and the side 96 forming the cup portion 92.

The ball 36 is shown having the slit 54 sectioning or partitioning the ball 36 into the sections 60 and 64. The other slits 56 and 58 and the section 62 are not visible in this view. The slit 54 allows the sections 60 and 64 to spread out or expand when the securing device 40 is inserted into the opening 52. In this manner, the sections 60 and 64 of the ball 36 open outwardly and contact the cup portion 92 of the mounting 18 when the ball 36 is positioned within the cup portion 92. The securing device 40 is illustrated as being a set screw, however, it is contemplated that the securing device 40 may take on different forms, such as a tack, a pin, a rivet, a nail, a spike, a wedge, or other similar device which enables the sections 60, 62, and 64 to spread apart when such securing device 40 is inserted into the opening 52 of the ball 36. Although the ball 36 is depicted, it is to be understood that the ball 38 is constructed and acts in a similar, if not identical, manner. As can be appreciated, when the ball 36 has been inserted into the cup portion 92 of the mounting 18, the securing device 40 is able to force the sections 60, 62, and 64 to spread out and come into frictional engagement with the cup portion 92. In this manner the ball 36 will be restricted from movement within the cup portion 92. In order to loosen the ball 36 from within the cup portion 92, the securing device 40 may be removed, either partially or entirely, from the opening 52 of the ball 36. It is also possible that the opening 52 may be threaded and the securing device 40 may be threaded for the securing device 40 to be screwed into the opening 52.

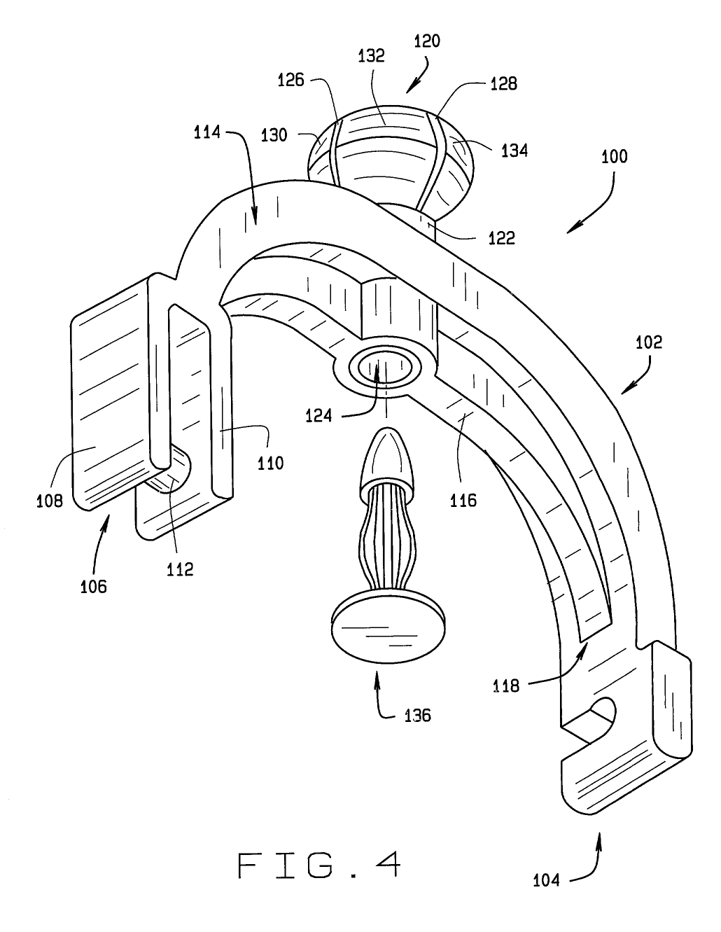

Referring now to FIG. 4, another preferred embodiment of an articulator 100 of the present invention is shown. The articulator 100 comprises a member 102 having a hooked end 104 and a forked end or fork member 106. The forked end 106 has an outer tine 108, an inner tine 110, and a pin portion 112 positioned between the tines 108 and 110. The member 102 is generally C-shaped and may be constructed from a resilient flexible material, such as plastic. The member 102 further comprises a central portion 114 and a reinforcing rib 116. The rib 116 spans or runs from the inner tine 110 to a point 118 which is short of the end 104. In other words, the rib 116 may be asymmetrical positioned along the central portion 114. Further, it is also possible that the rib 116 may be symmetrical along the central portion 114 or the rib 116 may span a distance which is less than the distance between the inner tine 110, the point 118, or the end 104. Additionally, the rib 116 may span the entire distance between the inner tine 110 and the end 104. Further, the width of the rib 116 is less than the width of the central portion 114. A ball or globe 120 is connected to the central portion 114 of the member 102 by use of a spline 122. The reinforcing rib 116 further includes an opening 124 which is aligned with the ball 120 and the spline 122 and extends through the spline 122 and into the ball 120. The ball 120 has a pair of slits or cuts 126 and 128 which segment or partition the ball 120 into quarter sections with three sections, sections 130, 132, and 134, being visible in this view. A securing device 136 is adapted to be inserted into the opening 124 to pass through the spline 122 and into the ball 120. The securing device 136 is capable of spreading open the sections 130, 132, and 134 of the ball 120. When the ball 120 is positioned within a mounting, such as the mounting 18, the ball 120 will be secured in place when the securing device 136 is inserted into the opening 124 through the spline 122 into the ball 120.

As can be appreciated, connecting together two of the members 102 forms the articulator 100. Although the hooked end 104 and the forked end 106 are depicted, it is also contemplated and possible to have other connecting mechanisms or structures for connecting together the members 102 to form the articulator 100. Further, although only two slits 126 and 128 and three sections 130, 132, and 134 are shown in the ball 120, it is to be understood that more or less slits and sections may be formed in the ball 120. The sections 130, 132, and 134 allow the ball 120 to expand in order to be secured within the mounting 18. The securing device 136 is a lock pin or wedge type device which is capable of forcing the sections 130, 132, and 134 apart when inserted into the opening 124, the spline 122, and the ball 120.

FIG. 5 illustrates a top view of the ball 120 of the member 102. The ball 120 has the slits 126 and 128 which quarter the ball 120 into four sections 130, 132, 134, and 138. The ball 120 has an opening 140 and each of the sections 130, 132, 134, and 138 has a rounded edge 142. The rounded edges 142 allow the ball 120 to contract when initially inserted into the mounting 18. The spline 122 is also shown connecting the ball 120 to the central portion 114. When the securing device 136 is inserted into the opening 124, the sections 130, 132, 134, and 138 will spread apart or expand within the mounting 18 to secure or lock the ball 120 in place. The opening 140 is in alignment with the opening 124.

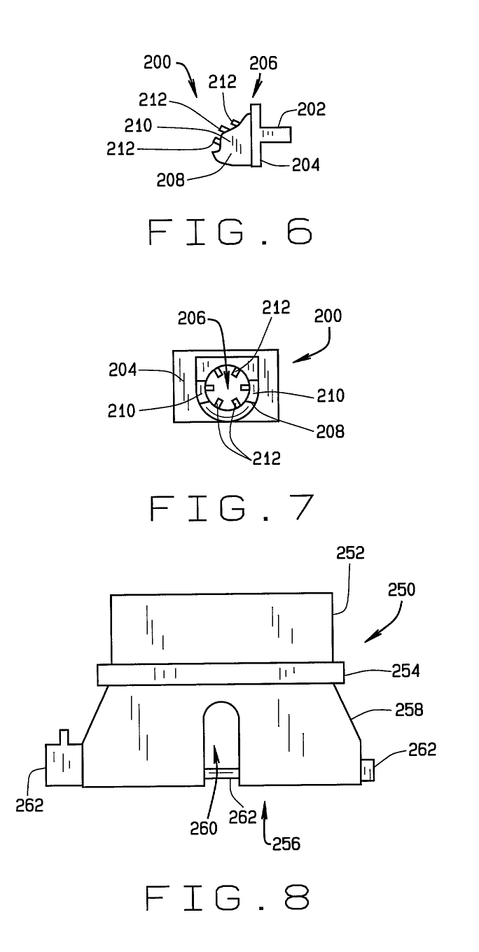

Referring now to FIG. 6, another preferred embodiment of a mounting 200 which may be used in conjunction with the articulators 10 or 100 is shown. The mounting 200 comprises a tongue portion 202 connected to a wall portion 204 with the tongue portion 202 and the wall portion 204 being T-shaped. The tongue portion 202 can be placed into a groove that may be formed in the dental cast, for example the dental casts 14 or 16. The mounting 200 further comprises a socket portion 206 being formed from a cup shaped side 208 and the wall 204. The side 208 has a pair of extensions 210, one of which is shown, which is employed to retain and support a ball, such as the balls 36, 38, or 120, when a ball is inserted into the socket portion 206. The mounting 200 further comprises locking or gripping teeth 212 that are spaced radially around the socket portion 206 and also extend out of the cup shaped side 208. The teeth 212 act to grip or further lock a ball, such as the ball 36, in place when a ball has been inserted into the socket portion 206. The frictional engagement between the teeth 212 and a ball helps to secure a ball within the socket portion 206 prior to using either of the securing devices 40, 42, or 136.

With reference now to FIG. 7, a front view of the mounting 200 is shown. The mounting 200 is shown having the socket portion 206 being formed from the cup shaped side 208 and the wall 204. The side 208 has the pair of extensions 210 which are used to capture and support a ball when inserted into the socket portion 206. The teeth 212 are shown extending around the interior of the socket portion 206.

FIG. 8 illustrates another preferred embodiment of a mounting 250 which may be used in conjunction with either the articulators 10 or 100. The mounting 250 comprises a tongue portion 252 connected to a wall portion 254 with the tongue portion 252 and the wall portion 254 being T-shaped. The tongue portion 252 can be placed into a groove that may be formed in the dental cast, for example the dental casts 14 or 16. The mounting 250 further comprises a socket portion 256 being formed from a cup shaped side 258 and the wall 254 with the socket portion 256 being adapted to receiving a ball, such as the ball 36, 38, or 120. The side 258 also has one or more slits 260 which are used to expand or contract the side 258. The mounting further comprises a cam mechanism 262 which is used to tighten or loosen the side 258 when a ball is inserted into the socket portion 256.

As can be appreciated from the above, the dental casts 14 and 16, when mounted to the articulators 10 or 100 can be easily moved or positioned with respect to each other. A technician can manipulate the casts 14 and 16 to rotate, move, or position the casts 14 and 16 in any desired direction or position for reviewing the dental appliance 26 associated with the casts 14 and 16. Once the proper alignment of the dental appliance 26 is accomplished, the securing or fastening devices 40, 42, or 136 may be used to lock or secure the ball portions 36, 38, or 120 in place. Additionally, if required, the fastening devices 40, 42, or 136 may be removed and reinserted many times. As can be appreciated, there is no need to use glue or other adhesives to secure the articulators 10 or 100 in place. Further, the articulators 10 or 100 may be shipped or transported back to a dentist for manipulation or confirmation by the dentist.

It should be recognized that the articulators 10 and 100 of the present invention could be constructed of various materials. Preferably, the articulators 10 and 100 will be of relatively lightweight material so that they can be easily constructed, assembled, positioned, secured in place, and removed. Further, the articulators 10 and 100 will be constructed of relatively inexpensive materials which will provide for the articulators 10 and 100 to be disposable or suitable for one time use.

From all that has been said, it will be clear that there has thus been shown and described herein an articulator which fulfills the various objects and advantages sought therefor. It will become apparent to those skilled in the art, however, that many changes, modifications, variations, and other uses and applications of the subject articulator are possible and contemplated. All changes, modifications, variations, and other uses and applications which do not depart from the spirit and scope of the invention are deemed to be covered by the invention, which is limited only by the claims which follow.

What is claimed is:

1. An articulator for positioning a pair of dental casts relative to each other, the articulator comprising a pair of members adapted to being connected to each other for pivotal movement relative to each other, each member comprising a central portion having a ball connected to the central portion by a spline, the ball being expandable for securing the ball within a mounting.

2. The articulator of claim 1 wherein the ball further comprises a slit for partitioning the ball into a pair of sections.

3. The articulator of claim 1 wherein the ball further comprises a slit for partitioning the ball into a pair of sections and an opening for receiving a securing device for expanding the sections outwardly.

4. The articulator of claim 3 wherein the securing device is a pin.

5. The articulator of claim 3 wherein the securing device is a wedge.

6. The articulator of claim 3 wherein the opening is threaded and the securing device is threaded.

7. The articulator of claim 1 further comprising a pair of mounting members, the mounting members being mountable to each of the dental casts and the mounting members comprising a cup portion for receiving the ball with each of the cup portions having locking teeth.

8. The articulator of claim 1 wherein ball further comprises a pair of slits for sectioning the ball into quarters and an opening for receiving a securing device for expanding the quarters outwardly.

9. An articulator for positioning a pair of dental casts relative to each other, the articulator comprising a pair of members adapted to being connected to each other for pivotal movement relative to each other, each member comprising a central portion having a ball connected to the central portion by a spline, an opening in the central portion and aligned with the spline and the ball, the ball being expandable, and a securing device adapted for insertion into the opening, through the spline and into the ball for expanding the ball when the ball is positioned within a mounting.

10. The articulator of claim 9 wherein the ball further comprises a slit for partitioning the ball into a pair of sections.

11. The articulator of claim 9 wherein the ball further comprises a slit for partitioning the ball into a pair of sections and an opening with each of the sections being rounded at the opening.

12. The articulator of claim 9 wherein the securing device is a pin.

13. The articulator of claim 9 wherein the securing device is a wedge.

14. The articulator of claim 9 wherein the opening is threaded and the securing device is threaded.

15. The articulator of claim 9 wherein ball further comprises a pair of slits for sectioning the ball into quarters and an opening which is aligned with the opening in the central portion.

16. The articulator of claim 9 wherein the securing device is a locking pin.

17. An articulator for positioning a pair of dental casts relative to each other, the articulator comprising a pair of members adapted to being connected to each other for pivotal movement relative to each other, each member comprising a central portion and a ball connected to each of the central portions, the ball being expandable, and a securing device for expanding the ball when the ball is inserted into a mounting.

18. The articulator of claim 17 wherein each of the balls further comprises a slit for partitioning the ball into a pair of sections and an opening for receiving the securing device for expanding the sections outwardly.

19. The articulator of claim 17 wherein each of the balls further comprises a pair of slits for sectioning the ball into quarters and an opening for receiving the securing device for expanding the quarters outwardly.

20. The articulator of claim 17 wherein each of the balls further comprises a slit for partitioning the ball into a pair of sections and an opening with each of the sections being rounded at the opening.
